(19) United States
(12) Patent Application Publication
(10) Pub. No.: US 2013/0144868 A1
(43) Pub. Date: Jun. 6, 2013

(54) Post Building and Search Creation

(71) Applicants: Steven Wayne Ickman, Snoqualmie, WA (US); William Lawrence Portnoy, Woodinville, WA (US)

(72) Inventors: Steven Wayne Ickman, Snoqualmie, WA (US); William Lawrence Portnoy, Woodinville, WA (US)

(73) Assignee: Microsoft Corporation, Redmond, WA (US)

(21) Appl. No.: 13/308,761

(22) Filed: Dec. 1, 2011

(51) Int. Cl. G06F 17/30

(52) U.S. Cl. 707/722; 707/E17.014

(57) ABSTRACT

Various embodiments provide a social search engine that enables a user to create posts that are shared with various other users and which can be dynamically updated and modified by the user and/or others. In at least some embodiments, posts that are created by a user can be curated and tailored by the user to personalize their posts, as well as posts of others. Customization of posts can allow for creation of posts that serve as an “answer” for other search queries. Previously created posts can be revisited to add content such as links, media, and social interactions such as comments and the like. In at least some embodiments, a relevant post community can author a particular post which, in at least some instances, serve as an “answer.”

### BACKGROUND

Social network sites are currently popular. Many social network sites basically attempt to capture a social graph of connections among users. The users are often family members, classmates, and other prior acquaintances.

Current information retrieval systems allow individual users to employ search engines to explore various areas of knowledge stored in a data corpus, or a variety of different corpora, and accessible over a network. For instance, some information retrieval search engines allow a user to submit a query to search for information over a wide area network, such as the Internet. Conventionally, a user may submit queries that represent topics of interest to that user.

Searches using these conventional types of search engines are private, in that the originator of the query, and in fact the queries themselves along with their search results, are not shared with anyone else. If the user does wish to share this type of information, it is currently done by a manual, user-initiated, process which can be fairly cumbersome and error prone.

### SUMMARY

This Summary is provided to introduce a selection of concepts in a simplified form that are further described below in the Detailed Description. This Summary is not intended to identify key features or essential features of the claimed subject matter.

Various embodiments provide a social search engine that enables a user to create posts that are shared with various other users and which can be dynamically updated and modified by the user and/or others.

In at least some embodiments, posts that are created by a user can be curated and tailored by the user to personalize their posts, as well as posts of others. Customization of posts can allow for creation of posts that serve as an “answer” for other search queries. Previously created posts can be revisited to add content such as links, media, and social interactions, such as comments and the like. In at least some embodiments, a relevant post community can author a particular post which, in at least some instances, serve as an “answer.”

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example system in accordance with one or more embodiments.

FIG. 4 illustrates an example display in accordance with one or more embodiments.

FIG. 5 illustrates an example display in accordance with one or more embodiments.

FIG. 6 illustrates an example display in accordance with one or more embodiments.

FIG. 7 illustrates an example display in accordance with one or more embodiments.

FIG. 8 illustrates an example display in accordance with one or more embodiments.

FIG. 9 illustrates an example display in accordance with one or more embodiments.

FIG. 10 illustrates an example display in accordance with one or more embodiments.

FIG. 11 is a flow diagram that describes steps in a method in accordance with one or more embodiments.

FIG. 12 is a flow diagram that describes steps in a method in accordance with one or more embodiments.

FIG. 13 is a flow diagram that describes steps in a method in accordance with one or more embodiments.

FIG. 14 illustrates an example computing device that can be utilized to implement various embodiments described herein.

### DETAILED DESCRIPTION

Overview

Various embodiments provide a social search engine that enables a user to create posts that are shared with various other users and which can be dynamically updated and modified by the user and/or others.

In at least some embodiments, posts that are created by a user can be curated and tailored by the user to personalize their posts, as well as posts of others. Customization of posts can allow for creation of posts that serve as an “answer” for other search queries. Previously created posts can be revisited to add content such as links, media, and social interactions such as comments and the like. In at least some embodiments, a relevant post community can author a particular post which, in at least some instances, serve as an “answer.”

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

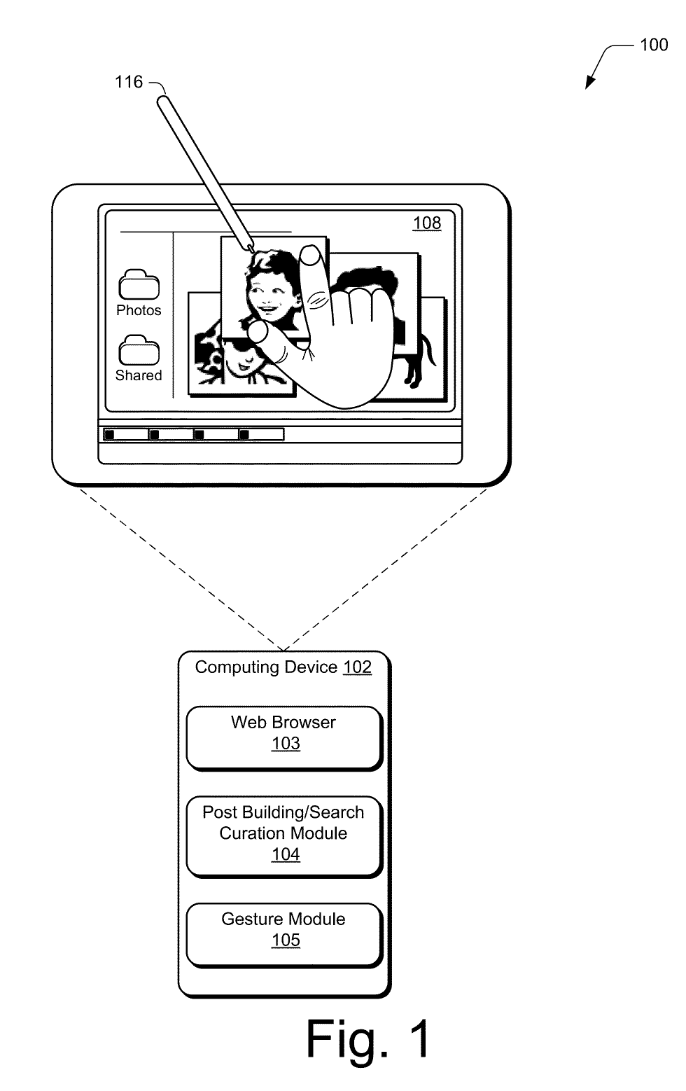

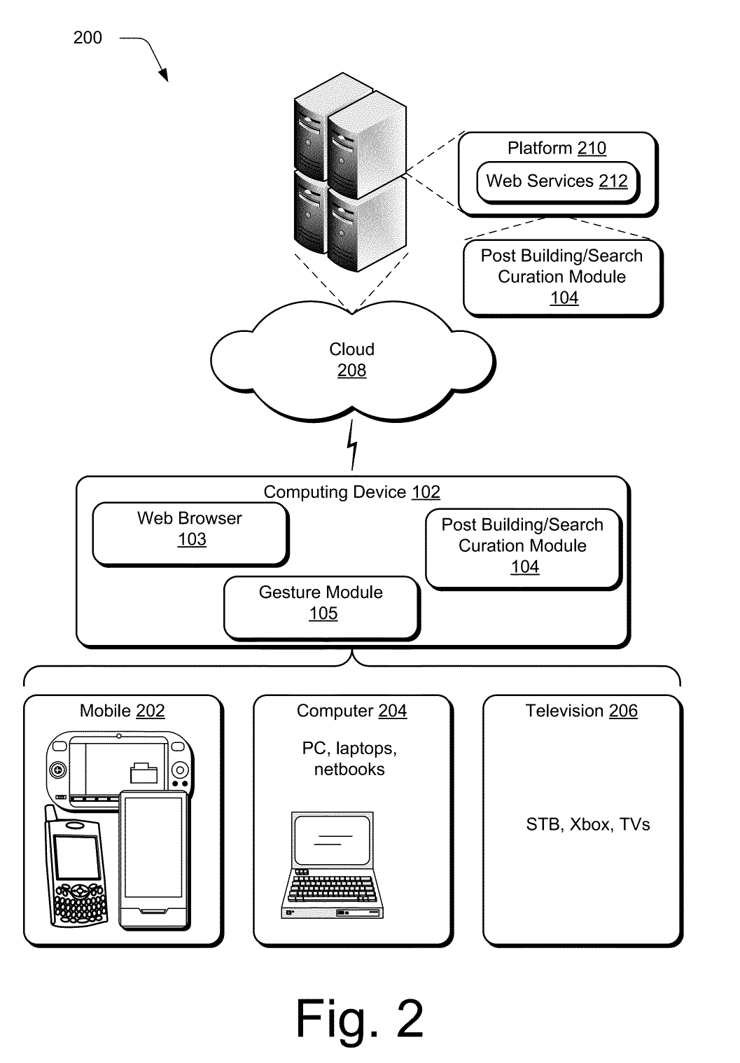

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a web browser 103, a post building/search curation module 104 configured to enable posts to be built and for searches to be curated as described below. Although post building/search curation module 104 is shown as representing a separate component from web browser 103, it can be implemented as a part of the web browser. The computing device 102 also includes a gesture module 105 that is configured to recognize various gestures, at least some of which are described herein.

Web browser 103 is representative of functionality that enables the user to browse navigable content on the network, such as the Internet. Using the web browser, a user can perform searches and, using associated search results, can use the post builder/search curation module 104 to build posts associated with searches and curate or modify those posts to tailor the posts to content the user desires to shared amongst other users who “follow” that particular user.

Post building/search iteration module 104 is representative of functionality that can, in at least some embodiments, work in concert with web browser 103 to support social search engine functionality that enables a user to create posts that are shared with various other users and which can be dynamically updated and modified by the user and/or others. In at least some embodiments, posts that are created by a user can be curated and tailored by the user to personalize their posts, as well as posts of others. Customization of posts can allow for creation of posts that serve as an “answer” for other search queries. Previously created posts can be revisited to add content such as links, media, and social interactions such as comments and the like. In at least some embodiments, a relevant post community can author a particular post which, in at least some instances, serve as an “answer.”

Computing device 102 also includes a gesture module 105, as noted above, that recognizes gestures that can be performed by one or more fingers, and causes operations to be performed that correspond to the gestures. The gestures may be recognized by module 105 in a variety of different ways. For example, the gesture module 105 may be configured to recognize a touch input, such as a finger of a user's hand as proximal to display device 108 of the computing device 102 using touchscreen functionality. Module 105 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand) and a stylus input (e.g., provided by a stylus 116). The differentiation may be performed in a variety of ways, such as by detecting an amount of the display device 108 that is contacted by the finger of the user's hand versus an amount of the display device 108 that is contacted by the stylus 116.

Thus, the gesture module 105 may support a variety of different gesture techniques through recognition and leverage of a division between stylus and touch inputs, as well as different types of touch inputs.

FIG. 2 illustrates an example system 200 showing the web browser 103, post building/search curation module 104, and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on. In at least some embodiments, web services 212 can be utilized to provide a public search system and search engine as described below. Further, in at least some embodiments, the post building/search curation module 104 can reside on platform 210 in the form of a web service, as by being embedded in a web site. For example, incoming visitors to a web page can have a referral URL and images provided, via http protocol or some other manner, that can be used to automatically build a post, thus providing an embedded community on another page entirely. In addition, platform 210 can provide access to or otherwise for a topics and statistics data store, as well as a corpus to be searched, as will become apparent below.

Thus, the cloud 208 is included as a part of the strategy that pertains to software and hardware resources that are made available to the computing device 102 via the Internet or other networks. For example, the post building/search curation functionality may be implemented in part on the computing device 102 as well as via a platform 210 that supports web services 212, such as a public search system and search engine as described just below.

The gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Example Post Building/Search Curation Module and Public Search System” describes functionality associated with a public search system in accordance with one or more embodiments. Next, a section entitled “Example Methods” describes example methods that can be implemented by the systems described herein, in accordance with one or more embodiments. Last, a section entitled “Example Device” describes aspects of an example device that can be utilized to implement one or more embodiments.

Having described example operating environments in which the post building/search curation functionality can be utilized, consider now a discussion of various embodiments.

Example Post Building/Search Curation Module and Public Search System

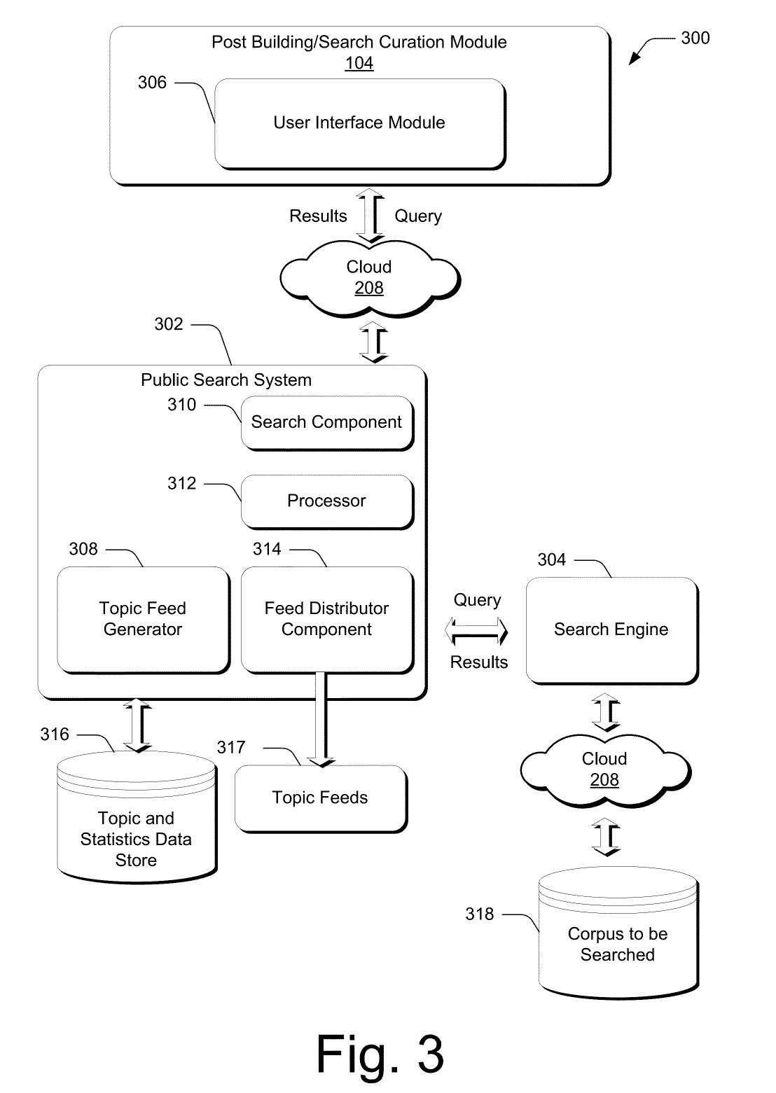

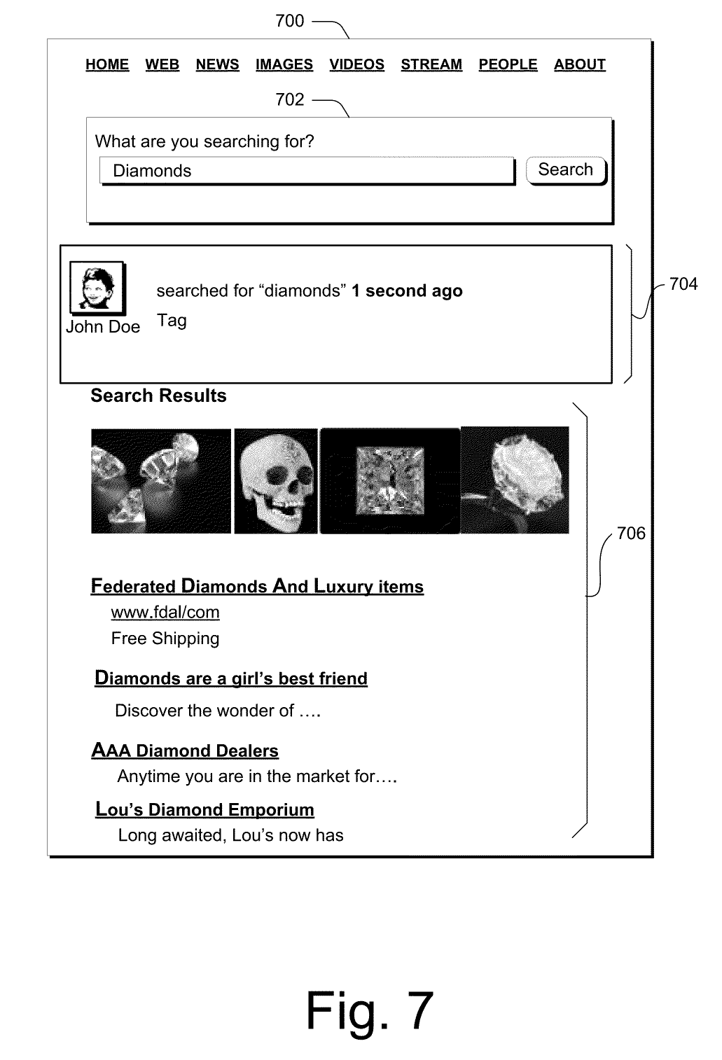

In the discussion that follows, FIGS. 3-6 describe general aspects of a social network including, an infrastructure that supports social networking functionality, as well as example displays that can be rendered through a suitable user interface in accordance with one or more embodiments. The discussion of these figures is intended to give the reader an appreciation for the general notion of a social network and how it can be employed within a relevant community of users who “follow” other users for the purpose of sharing search activities. Following this, FIGS. 7-10 illustrate example displays that are provided through a suitable user interface in which post building and search curation can be employed.

FIG. 3 is a block diagram of a social network 300 that includes post building/search curation module 104, a public search system 302 and a search engine 304, in accordance with one or more embodiments.

Post building/search curation module 104 includes a user interface module 306 that is configured to present a user interface that enables social aspects of a user's searching activities to be shared amongst users and vice versa. Public search system 302 includes a topic feed generator 308, a search component 310, a processor 312, and a feed distributor component 314. Social network 300 also includes a database 316 that maintains a topic and statistics data store, and a database 318 that represents one or more corpus to be search by search engine 304.

Post building/search curation module 104 enables communication with public search system 302 via a suitably configured network, such as cloud 208.

In operation, the user interface module 306 enables a user to set up an account which includes, for example, a user name and password. The user can input these items through the interface module, and the items are stored in database 316. In one or more embodiments, the user can identify topics of interest which the user wishes to follow, or individual users or groups of users that the user wishes to follow as well. This information is also stored in database 316.

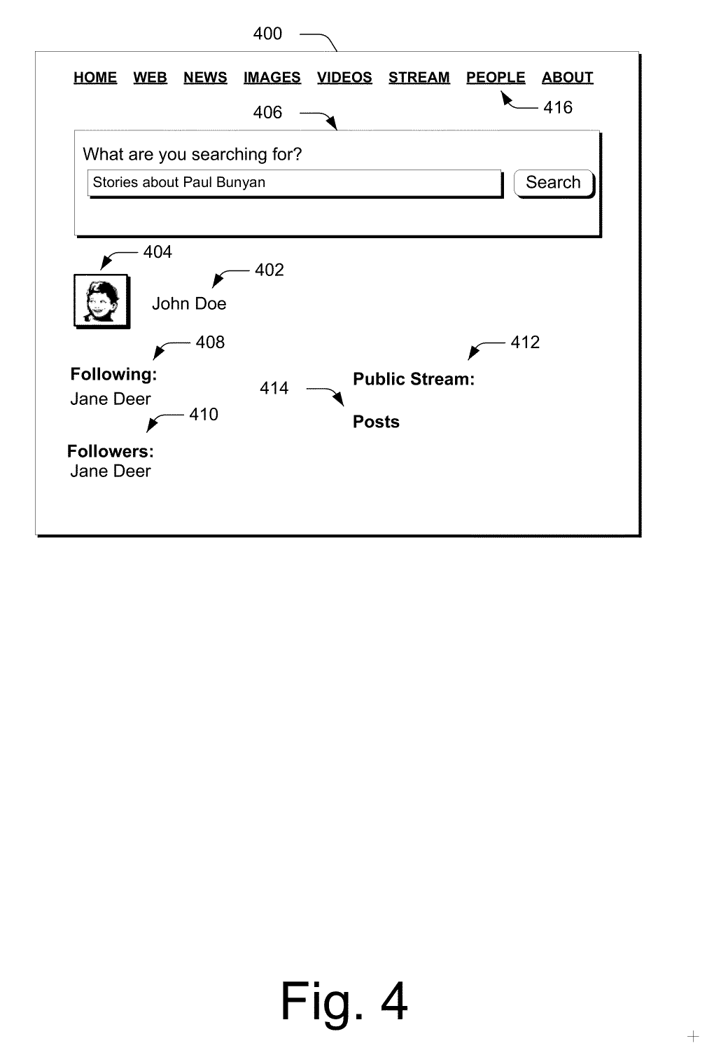

Once this is done, the user can log on to the system through, for example, an authentication component. The user interface module 306 can then generate a user interface display, such as the one shown in FIG. 4 at 400.

In the illustrative user interface display 400, the user's user name is “John Doe” and is displayed at 402, along with an image 404 which can be selected by John Doe to represent his user name. The display also presents a search box 406, which is a text box that allows the user to enter text (such as by using a keyboard) that represents a search query that the user wishes to have executed. Interface display 400 also displays the user names or topics that user 402 is following. For example, in the illustrated embodiment, those individuals whom the user is following are displayed at 408. User interface display 400 can also list other users that are following the user John Doe. For example, in this embodiment, Jane Doe, indicated at 410, is following John Doe. In addition, user interface display 400 can display a public stream of information 412 that can include a plurality of posts 414, corresponding to received topic feeds 317 (FIG. 3). Further, user interface display 400 can include a set of actuable elements, generally shown at 416. These elements can be actuated or selected through a suitable user interface operation, such as by clicking on an element using a pointing device (like a mouse).

For purposes of the description that follows, both FIGS. 3 and 4 will be referenced. In operation, when the interface display 400 is displayed by user interface module 306, the user can enter a desired query into search box 406. In the example shown in FIG. 4, the user has typed in “stories about Paul Bunyan”, which is submitted by way of user interface module 306 via cloud 208 to the public search system 302 in FIG. 3. The query is sent to topic feed generator 308.

The topic feed generator 308, in response to receiving the query, generates a topic feed that includes the query. The topic feed and query are output in the public stream 412 by feed distributor component 314 as a topic feed 317.

The feed distributor component 314 accesses database 316 to identify the followers of both John Doe (the user that submitted the query) and the followers of the subject matter content of the query itself For example, the subject matter content of the query is “Paul Bunyan”. Therefore, if any users have indicated that they wish to follow the topic category (or subject matter category) “Paul Bunyan”, then they would then be identified by feed distributor component 314 as a recipient of topic feed 317 as well. Feed distributor component 314 then distributes or publishes the topic feed 317 to those recipients that were identified.

Accordingly, upon submission of the query, the public search system 302 automatically publishes that query in a topic feed to relevant recipients, without any further input from the user.

The distribution or publication can be done in other ways as well. For instance, feed distribution component 314 can wait to update the system of a recipient until the recipient logs on to the system or otherwise engages the system. Similarly, the feed distribution component 314 can wait to distribute topic feed 317 to recipients until after the user has interacted with the results from the query.

It should be noted that, in FIG. 4, a wide variety of other approaches can be utilized to display information for the user. For example, public stream 412 may be divided into two streams, one which reflects posts from people that the user is following and another that reflects posts from topic areas that the user is following.

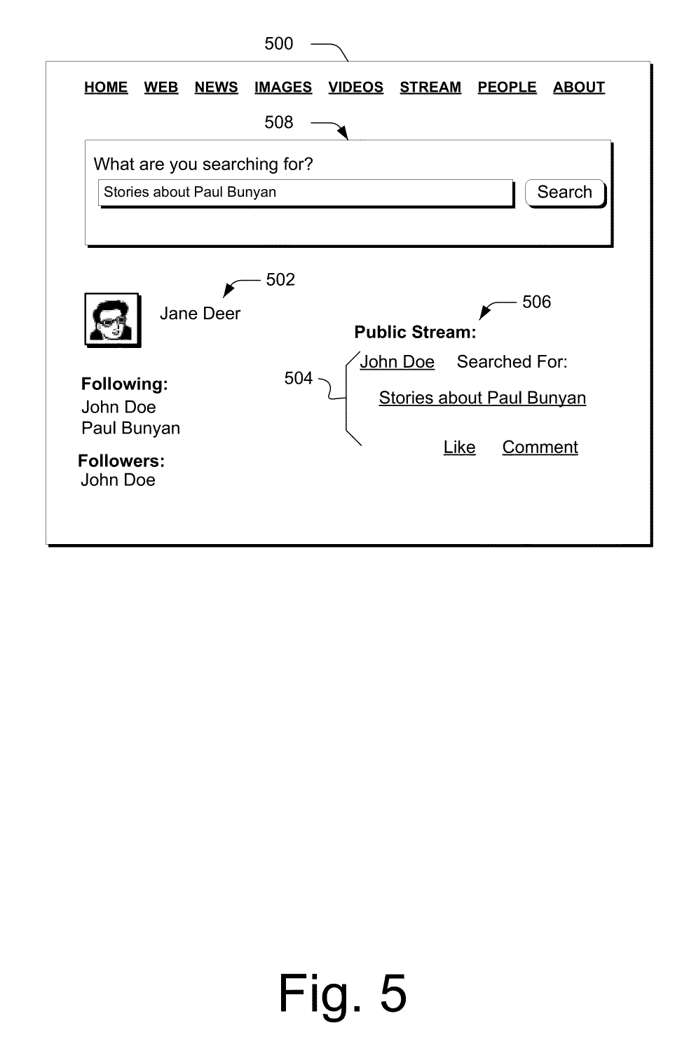

Once the topic feed 317 has been distributed and published to the identified recipients, a user interface module on the recipients' computing devices, similar to user interface module 306, can generate a display for those recipients. As an example, consider FIG. 5.

There, a display 500 is similar to that shown in FIG. 4, except that the user 502 is now “Jane Deer”. Jane Deer is one of the followers of John Doe, as indicated in FIG. 4. Therefore, the topic feed 317 (FIG. 3) generated from John Doe's activity will be distributed to, and published at, a user interface module residing at Jane Deer's device.

The topic feed 317 is posted as a post 504 on the public stream 506 of the user interface display shown in FIG. 5. Public stream 506 includes the post “John Doe searched for stories about Paul Bunyan”. Both the source of the post and the search which is the subject matter of the post are actuable or selectable links that can be selected to perform a navigation. Accordingly, if the user of the system that generated the display in FIG. 5 (that is, Jane Deer) clicks on “John Doe” or “Stories about Paul Bunyan”, the user's system will perform a corresponding navigation. Specifically, if the user clicks on “John Doe”, which contains the source of the post, then the user's system links the user to the home page of John Doe by navigating to the home page for John Doe, and presents Jane Deer with a user interface display such as that shown in FIG. 4. Alternately or additionally, if Jane Deer clicks on “Stories about Paul Bunyan”, the results for that query will be returned to Jane Deer.

At the same time that feed distributor component 314 distributes the topic feed generated by topic feed generator 308, search component 310 can also provide the query, under the influence of processor 312, to search engine 304 for execution against database 318. Search engine 304 may be a conventional information retrieval search engine that searches the web for content associated with the query that was input. Search engine 304 can alternatively be implemented in search component 310.

Search engine 304 executes the search against database 318 and returns search results to search component 310 in public search system 302. Search component 310 then returns the results to user interface module 306 associated with the author of the query, i.e., John Doe.

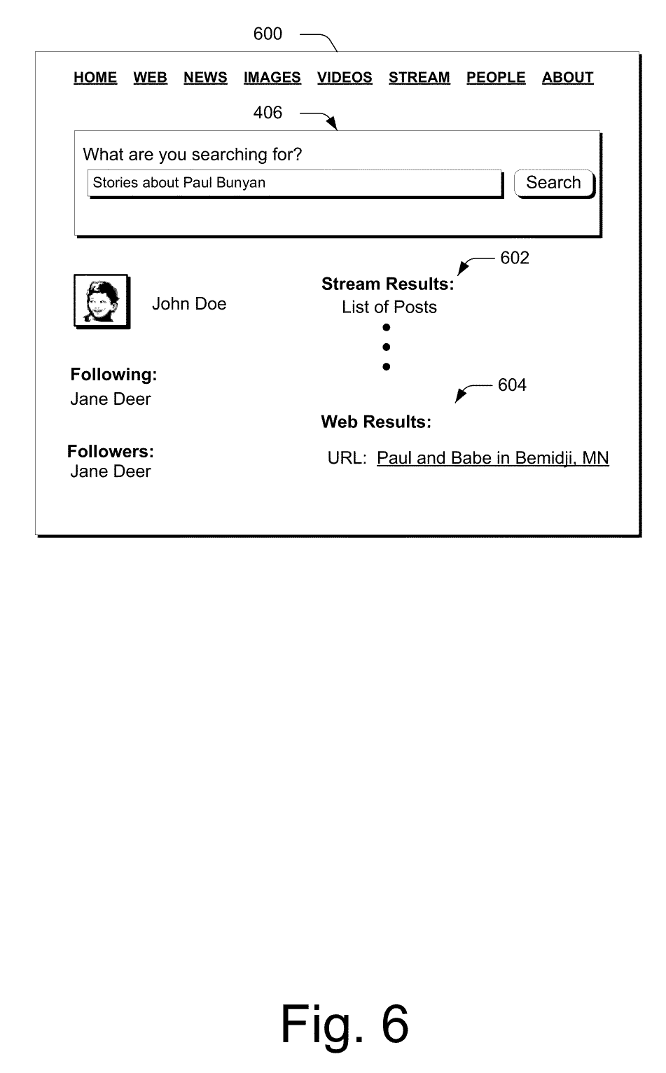

In one or more embodiments, not only does search component 310 pass the query on to search engine 304 for execution against database 318, but search component 310 can also search the records stored in database 316 for any other posts that are relevant to the subject matter of the query. For example, John Doe or other users of public search system 302 may have submitted similar queries, and therefore topic feeds 317 may have already been generated for those similar queries. Thus, search component 310 can search database 316 for posts from previously generated topic feeds 317 that are relevant to the query. These other posts can then be returned to the user through user interface module 306 as stream results. In other embodiments, the records returned from searching database 316 can be used to re-order the search results returned from search engine 304 or a search engine other than search engine 304. As an example, consider FIG. 6.

There, user interface module 306 (FIG. 3) has generated a display 600 for the user who submitted the query. The display shown in FIG. 6 is similar, in some respects, to that shown in FIG. 4. In FIG. 6, search results are presented in two separate categories. The first category is a stream results section 602 and the second category is a web results section 604.

Under the web results section 604, the search results generated by search engine 304 are presented to the user as user actuable or selectable links. By way of example, one of results is a URL entitled “Paul and Babe in Bemidji, Minn.”. If the user clicks on one of these results, an ensuing navigation will navigate to the web page, or other corpus entry, that spawned that search result.

Under stream results section 602, display 600 lists all posts which contain search results that are relevant to the query. That is, if database 316 includes posts that are relevant to the query, those posts are also displayed in the stream results section 602, along with the web results in the web results section 604. Again, to the extent that there are actuable links in stream results posted in stream results section 602, the user can simply click on those actuable links and cause a navigation to the underlying source that spawned the link.

Having considered an example social search engine that enables a user to create posts that are shared with various other users, consider now embodiments in which posts can be specifically built or crafted and curated dynamically in accordance with one or more embodiments.

FIG. 7 illustrates an example display 700 in accordance with one or more embodiments. Display 700 includes a search box 702, a post builder section 704, and a search results section 706.

In this particular example, a user has entered the search term “Diamonds” into search box 702. Correspondingly, a search is conducted and search results are displayed in search results section 706. Both images and links are displayed in the search results section 706. Preliminarily, the post builder section 704 is initially empty and the user is provided with an opportunity to build the post builder section 704 by adding content from the search results. Note, however, that “searched for ‘diamonds’ 1 second ago” is displayed and is shared out among those who follow the John Doe.

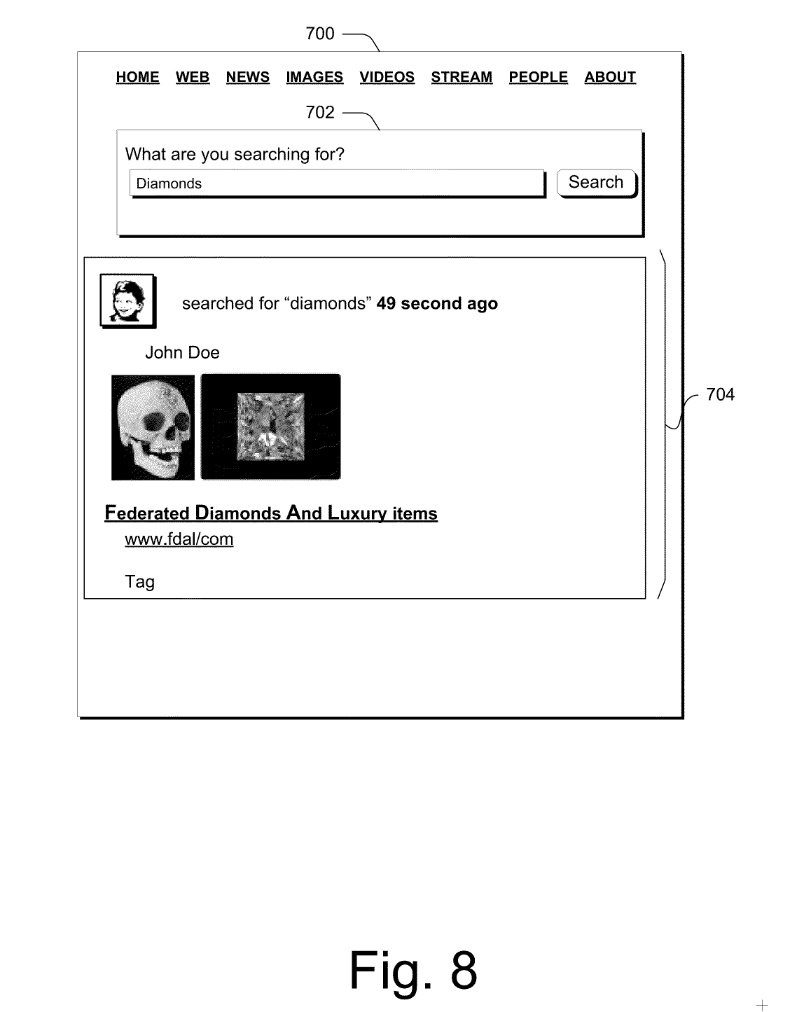

Once the search results are presented for the user in search results section 706, the user can begin to curate or build the post builder section 704. For example, by clicking on particular images or links and dragging the items to the post builder section 704, the user can add those images or links to their particular post builder section. Thus, instead of having their search results automatically published to those who follow them (which is still an option), the user can selectively add content that they consider to be relevant or interesting to their particular post builder section. As an example, consider FIG. 8.

There, the user has clicked on a few of the images and caused the images to be populated to the post builder section 704. The user has also added one of the search result links from the search results section. This added content serves as “answers” that the user considers relevant to their particular search. In one or more embodiments, the user can arrange or rearrange the contents within the post builder section 704. For example, the user may opt to place content that they consider more relevant at the top of their post builder section over other content that they may feel is less important. In this case, the user may consider the images more important than the links. The content that has been added to the post builder section can then be shared amongst users who follow John Doe.

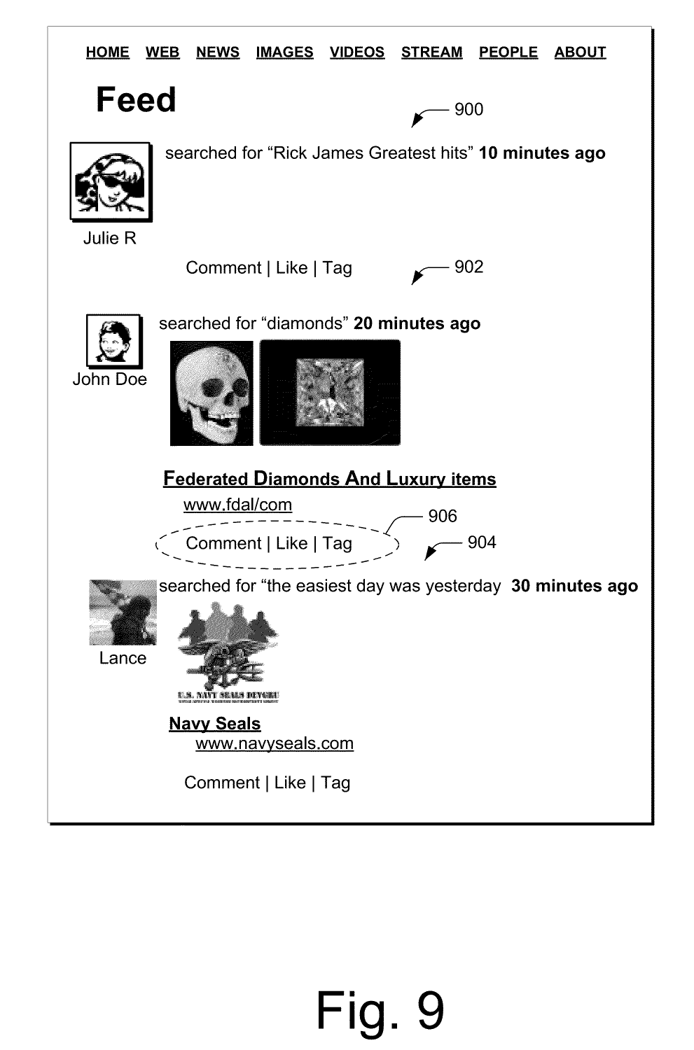

As an example, consider FIG. 9 which constitutes a feed page for a user who follows John Doe. In this particular example, three feeds for three different users are shown at 900, 902, and 904 respectively. Feed 900 is associated with the user named “Julie R” and indicates that Julie searched for “Rick James Greatest hits”. Feed 902 is associated with John Doe and contains information that John previously added to his post builder section. Feed 904 is associated with a user named “Lance” who search for “the easiest day was yesterday” and added some content to his associated post builder section.

In one or more embodiments, selectable options are displayed that allow a feed's user to socially interact with another user's search results that have been shared. But one example of selectable options are shown at 906. Here, options include “comment”, “like”, and “tag.”

Using the comment option, other users can comment on or otherwise added to posts of other users. For example, one user may comment that they found John Doe's search results interesting and informative. Yet, other users might comment on John Doe's search results and, in addition, add links or other content to supplement John's search results which, in turn, serve as “answers” to John's search. Other users may choose to tag John's search results. Accordingly, by enabling individual users to select the content that appears within their posts, and by enabling other users to add to, modify, or otherwise comment upon other users' posts, a community of knowledge and information can evolve around a user's search results.

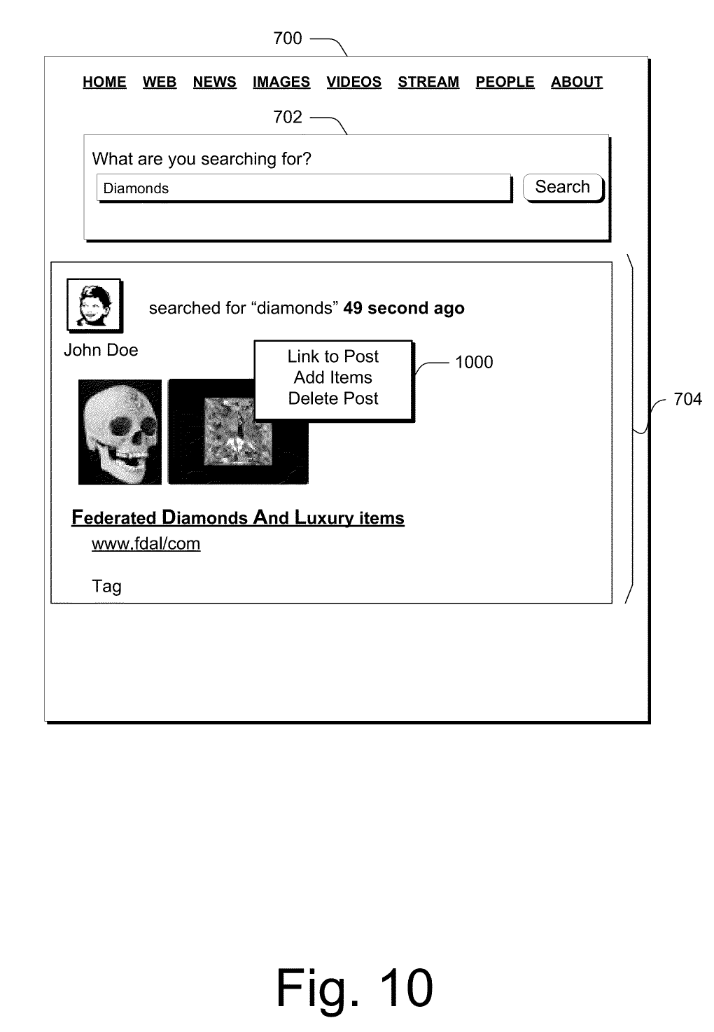

In one or more embodiments, users can revisit their previous posts to add links, media, and social interactions such as comments and the like. As an example, consider FIG. 10 which illustrates John Doe's display as shown in FIG. 8. In this particular example, a menu item 1000 is presented post builder section 704. This menu item can be presented in any suitable way such as through a drop-down menu feature, by hovering a mouse or other input device over a designated area, or by right-clicking within the post builder area 704, to name just a few.

In illustrated and described embodiment, menu item 1000 includes selections that enable a user to link to a post, add items to a post, or delete a post. Accordingly, the user can return to a particular post, modify or curate it in some way, and have it shared out to the relevant community of those who follow the particular user. For example, the user may add additional images or links, or make comments about other followers' posts.

Having considered various embodiments in which posts can be built and curated, consider now some example methods in accordance with one or more embodiments.

Example Methods

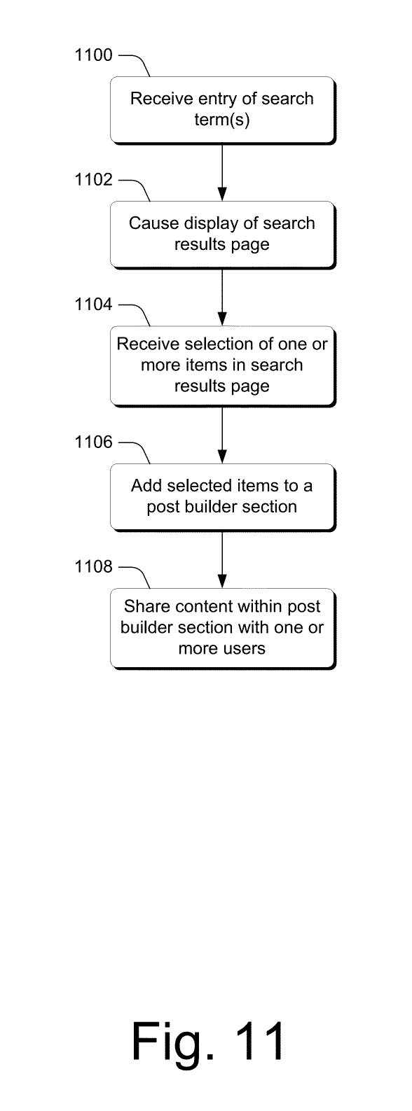

FIG. 11 is a flow diagram that describes steps in a method in accordance with one or more embodiments. The method can be performed in connection with any suitable hardware, software, firmware, or combination thereof. In at least some embodiments, the method can be performed by software in the form of a post building/search duration module such as module 104 in FIG. 1 which may or may not work in concert with a suitably-configured web browser.

Step 1100 receives entry of a search term or terms. This step can be performed in a suitable way. For example, this step can be performed by displaying a suitably-configured search box that comprises part of the user interface that can include a post builder section. Step 1102 causes display of a search results page. This step can be performed in any suitable way. The search results page includes search results associated with the search term or terms entered by the user. The search results page can include various content including, by way of example and not limitation, text, images, multimedia, links and the like. Step 1104 receives selection of one or more items in the search results page. This step enables a user to select items and have the items added to a post builder section of the user interface that can then be shared with other users. Step 1106 adds selected items to a post builder section. Examples of how this can be done are provided above. For example, this step can be performed by a post building module that resides locally on a client device. Alternately or additionally, this step can be performed by a post building module that reside on a third party computing device such as a server hosting a web site on which the post building module is embedded. Step 1108 shares content within the post builder section with one or more users. Examples of how this can be done are provided above.

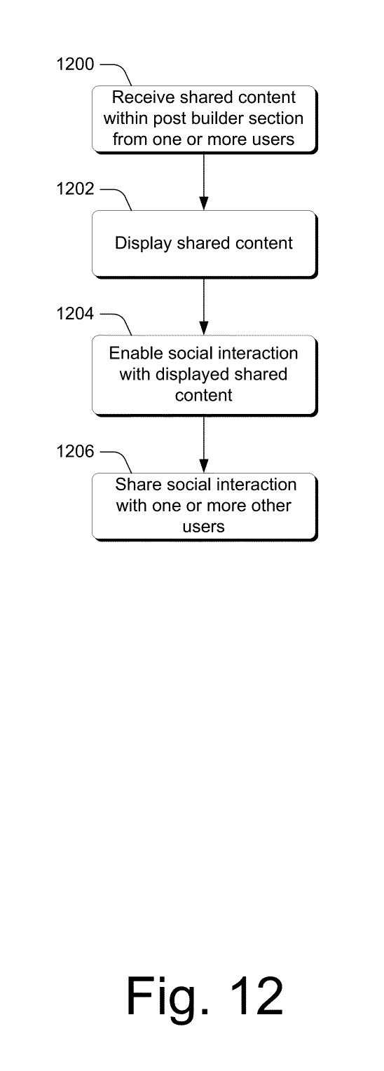

FIG. 12 is a flow diagram that describes steps in a method in accordance with one or more embodiments. The method can be performed in connection with any suitable hardware, software, firmware, or combination thereof. In at least some embodiments, the method can be performed by software in the form of a Web browser such as browser 103 in FIG. 1.

Step 1200 receives shared content within a post builder section from one or more users. The shared content can pertain to search results that pertain to the one or more users. Examples of how this can be done are provided above. Step 1202 displays the shared content and step 1204 enables social interaction with the displayed shared content. Examples of social interactions are provided above and include, by way of example and not limitation, enabling commentary as well as an opportunity to add content to a particular user's search results in a manner which enables a relevant community to build knowledge and information around the search results. Step 1206 shares of social interaction with one or more other users. In this manner, as knowledge and information is accumulated around a particular user's search results, this knowledge and information is collectively shared with a relevant following community.

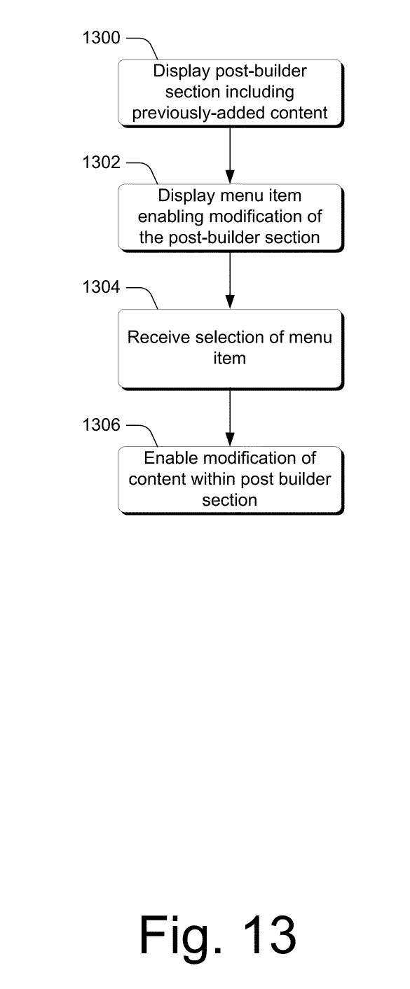

FIG. 13 is a flow diagram that describes steps in a method in accordance with one or more embodiments. The method can be performed in connection with any suitable hardware, software, firmware, or combination thereof. In at least some embodiments, the method can be performed by software in the form of a post building/search curation module such as module 104 in FIG. 1.

Step 1300 displays a post-builder section including previously-added content. Examples of how this can be done are provided above. Step 1302 displays one or more menu items that enable modification of the post-builder section. Examples of how this can be done are provided above. Step 1304 receives a selection of a menu item and step 1306 enables modification of content within the post-builder section. In this manner, a user can modify or otherwise curate content that was previously added to their post. That is, the user can add new content, remove previously-added content or delete a post all together.

Having described various embodiments, consider now a discussion of an example device that can be utilized to implement the embodiments described above.

Example Device

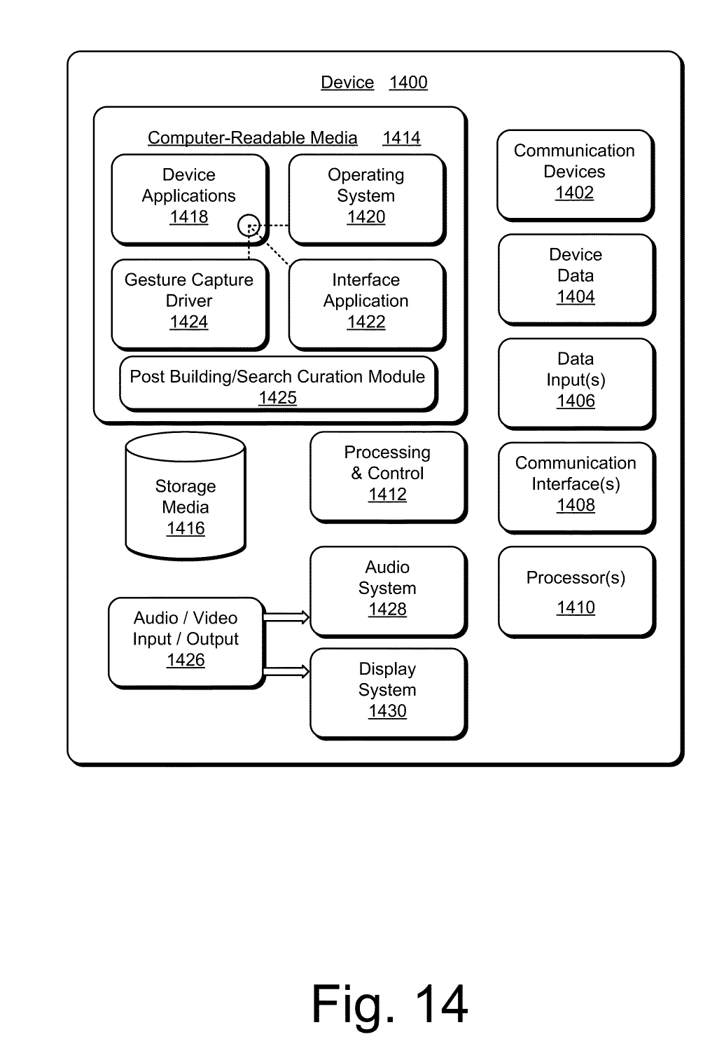

FIG. 14 illustrates various components of an example device 1400 that can be implemented as any type of portable and/or computer device as described with reference to FIGS. 1 and 2 to implement embodiments of the post building/search curation functionality described herein. Device 1400 includes communication devices 1402 that enable wired and/or wireless communication of device data 1404 (e.g., received data, data that is being received, data scheduled for broadcast, data packets of the data, etc.). The device data 1404 or other device content can include configuration settings of the device, media content stored on the device, and/or information associated with a user of the device. Media content stored on device 1400 can include any type of audio, video, and/or image data. Device 1400 includes one or more data inputs 1406 via which any type of data, media content, and/or inputs can be received, such as user-selectable inputs, messages, music, television media content, recorded video content, and any other type of audio, video, and/or image data received from any content and/or data source.

Device 1400 also includes communication interfaces 1408 that can be implemented as any one or more of a serial and/or parallel interface, a wireless interface, any type of network interface, a modem, and as any other type of communication interface. The communication interfaces 1408 provide a connection and/or communication links between device 1400 and a communication network by which other electronic, computing, and communication devices communicate data with device 1400.

Device 1400 includes one or more processors 1410 (e.g., any of microprocessors, controllers, and the like) which process various computer-executable or readable instructions to control the operation of device 1400 and to implement the embodiments described above. Alternatively or in addition, device 1400 can be implemented with any one or combination of hardware, firmware, or fixed logic circuitry that is implemented in connection with processing and control circuits which are generally identified at 1412. Although not shown, device 1400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1400 also includes computer-readable media 1414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1400 can also include a mass storage media device 1416.

Computer-readable media 1414 provides data storage mechanisms to store the device data 1404, as well as various device applications 1418 and any other types of information and/or data related to operational aspects of device 1400. For example, an operating system 1420 can be maintained as a computer application with the computer-readable media 1414 and executed on processors 1410. The device applications 1418 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 1418 also include any system components or modules to implement embodiments of the techniques described herein. In this example, the device applications 1418 include an interface application 1422 and a gesture-capture driver 1424 that are shown as software modules and/or computer applications. The gesture-capture driver 1424 is representative of software that is used to provide an interface with a device configured to capture a gesture, such as a touchscreen, track pad, camera, and so on. Alternatively or in addition, the interface application 1422 and the gesture-capture driver 1424 can be implemented as hardware, software, firmware, or any combination thereof. In addition, computer readable media 1414 can include a post building/search curation module 1425 that functions as described above.

Device 1400 also includes an audio and/or video input-output system 1426 that provides audio data to an audio system 1428 and/or provides video data to a display system 1430. The audio system 1428 and/or the display system 1430 can include any devices that process, display, and/or otherwise render audio, video, and image data. Video signals and audio signals can be communicated from device 1400 to an audio device and/or to a display device via an RF (radio frequency) link, S-video link, composite video link, component video link, DVI (digital video interface), analog audio connection, or other similar communication link. In an embodiment, the audio system 1428 and/or the display system 1430 are implemented as external components to device 1400. Alternatively, the audio system 1428 and/or the display system 1430 are implemented as integrated components of example device 1400.

Conclusion

Various embodiments provide a social search engine that enables a user to create posts that are shared with various other users and which can be dynamically updated and modified by the user and/or others.

In at least some embodiments, posts that are created by a user can be curated and tailored by the user to personalize their posts, as well as posts of others. Customization of posts can allow for creation of posts that serve as an “answer” for other search queries. Previously created posts can be revisited to add content such as links, media, and social interactions such as comments and the like. In at least some embodiments, a relevant post community can author a particular post which, in at least some instances, serve as an “answer.”

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A computer-implemented method comprising:
receiving entry of one or more search terms by displaying a search box that comprises part of a user interface that includes a post builder section;
causing display search results associated with the one or more search terms;
receiving selection of one or more items in the search results; and
responsive to receiving selection of the one or more items, adding selected items to the post builder section.

2. The method of claim 1 further comprising sharing content within the post builder section with one or more users.

3. The method of claim 1, wherein the post builder section is configured to enable addition of images and links thereto.

4. The method of claim 1, wherein the post builder section is configured to include text identifying a search conducted by a user.

5. The method of claim 1, wherein the post builder section is configured to include text identifying a search conducted by a user, the post builder section being separate from a search box in which the one or more search terms were received.

6. The method of claim 1, wherein the post builder section is configured to enable rearrangement of items within the post builder section.

7. One or more computer readable storage media embodying computer-readable instructions which, when executed, implement a method comprising:
receiving shared content within a post builder section from one or more users, the shared content pertaining to search results;
displaying the shared content; and
enabling social interaction with the displayed shared content.

8. The one or more computer readable storage media of claim 7, wherein enabling social interaction comprises enabling commentary with respect to the shared content.

9. The one or more computer readable storage media of claim 7, wherein the shared content includes one or more links to search results.

10. The one or more computer readable storage media of claim 7, wherein enabling social interaction comprises enabling links to be added to the shared content by at least one user other than the one or more users.

11. The one or more computer readable storage media of claim 7, wherein enabling social interaction further comprises sharing the social interaction with the one or more users.

12. One or more computer-readable storage media embodying computer-readable instructions comprising:
a post building/search curation module configured to:
display a post builder section including previously-added content pertaining to search results;
display one or more menu items that enable modification of the post builder section;
receive a selection of a menu item; and
responsive to selection of the menu item, enable modification of content within the post builder section.

13. The one or more computer-readable storage media of claim 12, wherein the post building/search curation module is configured to enable modification of the content by enabling new content to be added.

14. The one or more computer-readable storage media of claim 12, wherein the post building/search curation module is configured to enable modification of the content by enabling content to be removed.

15. The one or more computer-readable storage media of claim 12, wherein the post building/search curation module is configured to enable modification of the content by enabling a post within the post builder section to be removed.

16. The one or more computer-readable storage media of claim 12, wherein the post building/search curation module is configured to present a search box in which one or more search terms can be entered.

17. The one or more computer-readable storage media of claim 12, wherein the post building/search curation module is configured to:
present a search box in which one or more search terms can be entered; and
enable one or more search results to be added to the post builder section.

18. The one or more computer-readable storage media of claim 12, wherein the post building/search curation module is configured to present a search box in which one or more search terms can be entered and cause at least some search results to be shared with one or more users.

19. The one or more computer-readable storage media of claim 12, wherein the post building/search curation module is configured to present a search box in which one or more search terms can be entered and to include text, separate from the search box, identifying a search conducted by a user.

20. The one or more computer-readable storage media of claim 12, wherein the post builder section is configured to enable rearrangement of items within the post builder section.
